(19) United States
(12) Patent Application Publication
(10) Pub. No.: US 2014/0207876 A1
(43) Pub. Date: Jul. 24, 2014

(54) System and Method for Routing Messages Over a Network

(71) Applicant: MYRON S. HERRON, JR., GREENSBORO, NC (US)

(72) Inventor: MYRON S. HERRON, JR., GREENSBORO, NC (US)

(21) Appl. No.: 13/747,698

(22) Filed: Jan. 23, 2013

(51) Int. Cl. H04L 12/58

(52) U.S. Cl. CPC H04L 51/34
USPC 709/206

(57) ABSTRACT

Embodiments of the invention relate to a computer system and method for routing messages over a network, including messages originating from mobile devices and messages destined for emergency services. Initial messages may be associated with a sessionless protocol, e.g., SMS. An initial message embodying a text-based communication that originated from a mobile device at a location and time may be received, and a service query comprising the location of the mobile device may then be transmitted. In response to the service query, the recipient of the message may be identified along with a location, with the initial message being forwarded through the network to the identified recipient. If that initial message lacks sufficient location information, a location query may be transmitted, and a response to the location query that comprises sufficient information about the location of the mobile device may be used to formulate the service query, ensuring delivery of the message to the intended recipient with location information.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records but otherwise reserves all copyrights whatsoever.

### BACKGROUND

Voice and data networks are widely used for exchanging messages, such as text messages. For example, short message service (“SMS”) is a text messaging service that was originally defined as part of the GSM protocols for digital cellular phone networks and is now used extensively worldwide. Other protocols and services (e.g., Multimedia Messaging Service, or “MMS”, and Apple's iMessage®, among a great many others), may provide similar functionality and may, depending on the service, augment text messaging with other multimedia context.

Messages exchanged through such services may or may not be limited to text, depending on the protocol, implementation, or both. For convenience, messages sent thereby may be referred to as “text messages”, and the services may be referred to as “text messaging”. But absent an explicit statement, or unless context requires otherwise, these terms may be understood to include messages and messaging according to one or more such protocols, standards, or both, that may include media such as sound and/or still and/or moving pictures.

Consistent with the foregoing, and reflecting common use, “text messaging” excludes telephone calls and similar forms of voice communication.

Text messaging may potentially be used for any type of communication. In some ways, text messaging might seem suitable for emergency communication. Text messages are delivered nearly in real time, which may make them suitable for urgent communication. Text messaging may use less bandwidth than voice calling, allowing text messages to go through where weak signals or batteries would interfere with voice calling. Text messages may also serve, e.g., when a 911 caller is injured, unable to speak, or has hearing or speech disabilities that would make a voice call difficult.

Despite these seeming advantages, emergency services such as 911 may not be available by text messaging due to technical limitations. Current technology may not allow a service provider to ensure that messages requesting emergency services are timely directed to the appropriate recipient. For example, the identity of that appropriate recipient may depend on the location of the sender's device, yet text messaging may not supply the location data needed to direct the messages properly.

Moreover, text messaging is typically sessionless, which means that nothing in the protocols supports automatically relating a text message to a previous one. Consequently, if a mobile user moves while in communication with emergency services, the change of location may cause a change in the recipient of the text messages, possibly keeping vital information from dispatchers or responders, or at least sowing confusion.

### BRIEF SUMMARY OF THE INVENTION

Embodiments of the invention relate to delivering messages over a network, including messages from a mobile device destined to a provider of emergency services.

According to an embodiment of the invention, a method of routing electronic messages in a voice network, a data network, or both, may be carried out by a computer system that comprises one or more processors, one or more network interfaces coupled to at least one of the processors, and one or more computer-readable storage media coupled to at least one of the processors. The method comprises receiving through at least one of the interfaces an initial message embodying a text message that originated from a mobile device at a first location and a first time and, in response to receiving the initial message, automatically transmitting through at least one of the interfaces a service query that comprises the first location. The method also comprises receiving, through at least one of the interfaces, a response to the service query that identifies a recipient of the message, the recipient being associated with the first location and, in response to receiving the response to the service query, automatically retransmitting the initial message through at least one of the interfaces to the identified recipient.

In an embodiment of the invention, the method comprises, in response to receiving the initial message, automatically determining that the initial message lacks location information sufficient to formulate the service query. The method further comprises, in response to determining that the initial message lacks sufficient location information, automatically transmitting through at least one of the interfaces a location query and receiving through at least one of the interfaces a response to the location query that comprises sufficient information about the location of the mobile device to formulate the service query.

In an embodiment of the invention, the method comprises, in response to receiving the initial message, automatically creating a session that is associated with the initial message, where the session has a timeout. The method comprises, at a second time subsequent to the first time, receiving through at least one of the interfaces a second message embodying a second text message from the mobile device. The method also comprises, in response to receiving the second message, automatically determining that the timeout has not expired and resetting the timeout and automatically retransmitting the second message through at least one of the interfaces to the recipient.

According to an embodiment of the invention, at the second time, the mobile device is at a second location that is not associated with the recipient.

In an embodiment of the invention, the computer system is programmed so that upon determining, in response to receiving the second message, that the timeout has expired, the computer system at least: (1) automatically transmits through at least one of the interfaces a second service query that comprises the second location; (2) receives, through at least one of the interfaces, a response to the second service query that identifies a second recipient, the second recipient being associated with the second location; and (3) in response to receiving the response to the second service query, automatically retransmits the second message through at least one of the interfaces to the second recipient.

Further embodiments of the invention include computer systems that include one or more processors, one or more network interfaces coupled to at least one of the processors, and one or more computer-readable storage media encoded with instructions that, when executed by at least one of the processors, cause the computer systems to carry out one or more of the above methods. Still further embodiments of the invention include computer-readable storage media encoded with such instructions.

In embodiments of the invention, a network for routing messages comprises a web services server, an emergency services routing protocol or protocols (or proxies), an emergency call routing function or functions, a location information server, and a call center with automated agents or live personnel.

In embodiments of the invention, a computer system for routing messages over a network comprises one or more processors and one or more computer-readable storage media encoded with instructions that, when executed by at least one of the processors, cause the computer system at least to carry out a method of routing messages over a network.

### BRIEF DESCRIPTION OF THE DRAWINGS

FIG. 1 is a block diagram depicting an exemplary computer system with which embodiments of the invention may at least partially be implemented.

FIG. 2 is a block diagram depicting an exemplary interconnected network with which embodiments of the invention may at least partially be implemented.

FIG. 3 is a flow diagram depicting routing of messages over a network in an embodiment.

### DETAILED DESCRIPTION OF PREFERRED EMBODIMENTS

According to embodiments of the invention, at a high level, a mobile device may originate a text message or SMS destined for the provider of emergency services, e.g., a 911 center. The caller's automatic number identification (“ANI”) and Presence Information Data Format with “location-info” element (“PIDF-LO”) that is transmitted with the message may enable a public safety answering point (“PSAP”) to identify the caller and provide services in a timely fashion. A web service may inspect the message for location information, e.g., a PIDF-LO. If such location information does not exist in the message, an HTTP-Enabled Location Delivery (“HELD”) query to a location information system (“LIS”) may be performed. The PIDF-LO can then be looked up in an Emergency Call Routing Function (“ECRF”) using the Location-to-Service Translation (“LoST”) protocol, and a next hop provided.

Embodiments of the invention may be implemented by systems using one or more programmable digital computers. Computer and computer systems in connection with embodiments of the invention may act, e.g., as workstations and/or servers, such as described below. Digital voice and/or data networks such as may be used in connection with embodiments of the invention may also include components (e.g., routers, bridges, media gateways, etc.) with similar architectures, although they may be adapted, e.g., as known in the art, for their special purposes. Because of this commonality of architecture, such network components may be considered as computer systems and/or components of computer systems when consistent with the applicable context.

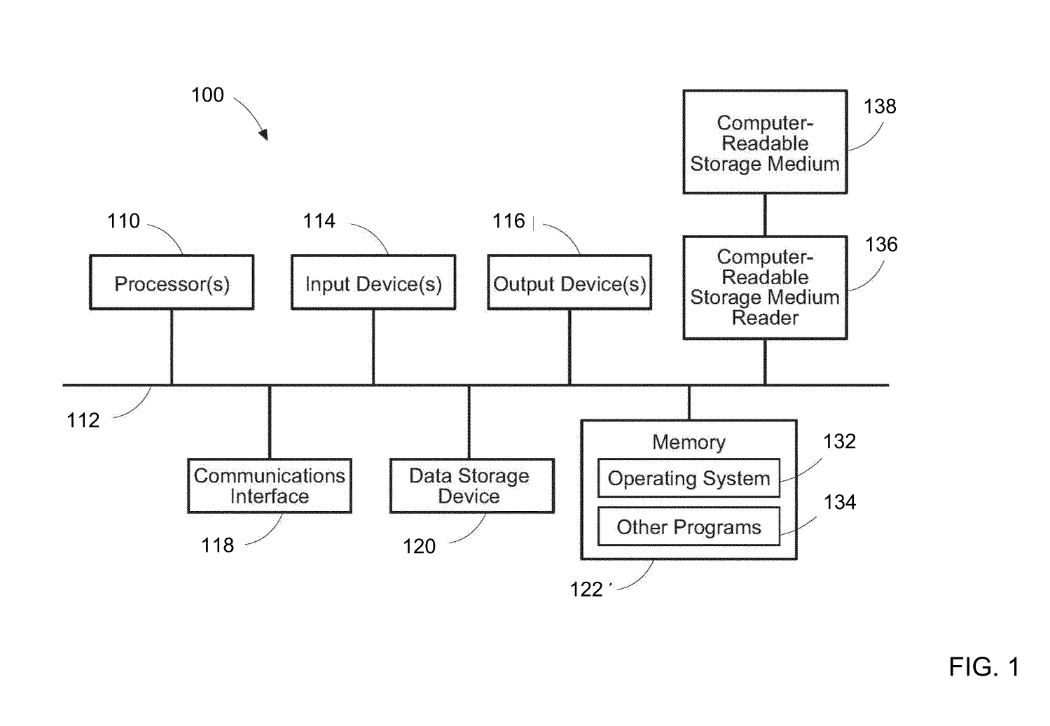

FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one data storage device 120 such as a magnetic disk or an optical disk, and memory 122 such as ROM and RAM, each coupled to the communications channel 112. The communications interface 118 may be coupled to a network (not depicted) such as the Internet.

Although the computer system 100 is shown in FIG. 1 to have only a single communications channel 112, a person skilled in the relevant arts will recognize that a computer system may have multiple channels (not depicted), including for example one or more busses, and that such channels may be interconnected, e.g., by one or more bridges. In such a configuration, components depicted in FIG. 1 as connected by a single channel 112 may interoperate, and may thereby be considered to be coupled to one another, despite being directly connected to different communications channels.

One skilled in the art will recognize that, although the data storage device 120 and memory 122 are depicted as different units, the data storage device 120 and memory 122 can be parts of the same unit or units, and that the functions of one can be shared in whole or in part by the other, e.g., as RAM disks, virtual memory, etc. It will also be appreciated that any particular computer may have multiple components of a given type, e.g., processors 110, input devices 114, communications interfaces 118, etc.

The data storage device 120 (FIG. 1) and/or memory 122 may store instructions executable by one or more processors or kinds of processors 110, data, or both. Some groups of instructions, possibly grouped with data, may make up one or more programs, which may include an operating system 132 such as Microsoft Windows®, Linux®, Mac OS®, or Unix®. Other programs 134 may be stored instead of or in addition to the operating system. It will be appreciated that a computer system may also be implemented on platforms and operating systems other than those mentioned. Any operating system 132 or other program 134, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 100 (FIG. 1) may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 136, such as, e.g., a magnetic disk drive, magneto-optical drive, optical disk drive, or flash drive, may be coupled to the communications channel 112 for reading from a CRSM 138 such as, e.g., a magnetic disk, a magneto-optical disk, an optical disk, or flash RAM. Alternatively, one or more CRSM readers may be coupled to the rest of the computer system 100, e.g., through a network interface (not depicted) or a communications interface 118. In any such configuration, however, the computer system 100 may receive programs and/or data via the CRSM reader 136. Further, it will be appreciated that the term “memory” herein is intended to include various types of suitable data storage media, whether permanent or temporary, including among other things the data storage device 120, the memory 122, and the CSRM 138.

The terms “computer-readable storage medium” and “computer-readable storage media” refer, respectively, to a medium and media capable of storing information. As such, both terms exclude transient propagating signals.

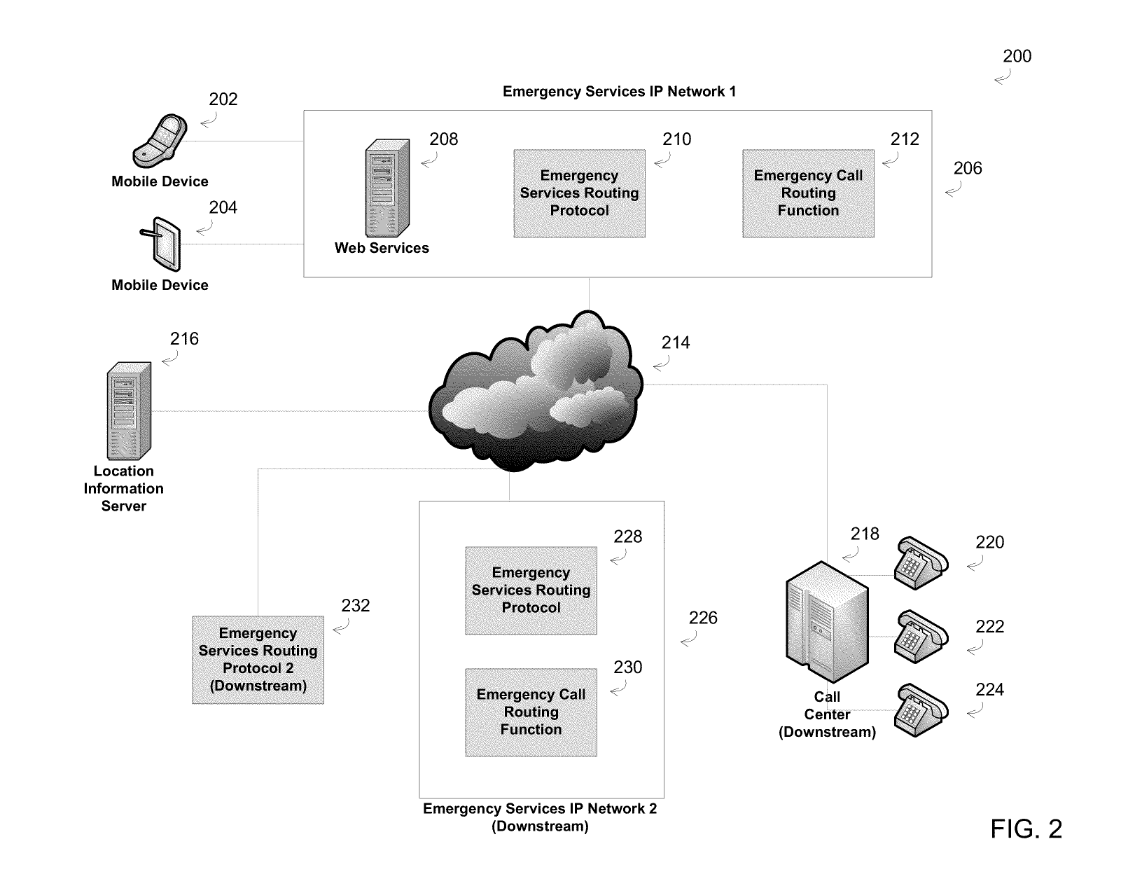

Two or more computer systems 100 (FIG. 1) may communicate, e.g., in one or more networks, via, e.g., their respective communications interfaces 118 and/or network interfaces (not depicted). FIG. 2 is a block diagram depicting an exemplary interconnected network 214 with which embodiments of the invention may at least partially be implemented. One use of a network 214 is to enable a computer system to provide services to other computer systems, consume services provided by other computer systems, or provide services to mobile devices. The network 214 may be connected to one or more other networks, e.g., via a router, and/or over an internet. An internet may comprise a network of networks 214. The term “the Internet” may refer to the worldwide network of interconnected, packet-switched data networks that uses the Internet Protocol (IP) to route and transfer data.

In an embodiment, network 214 may communicate with web services server 208, emergency services routing protocol (or proxy) (“ESRP”) 210, and emergency call routing function (“ECRP”) 212, all of which may communicate with each other, and which together may be housed, physically or virtually, within a first Emergency Services IP Network (“ESInet 1”).

According to some embodiments, ESInet 1 may comprise its own network or use proprietary protocols, e.g., ESInet 1 may be based on a Session Initiation Protocol (“SIP”) Trunking service.

According to some embodiments, web services server 208 in ESINet 1 (206) may be configured to enforce standards on each call or message, and provide other functionality.

In the embodiment of FIG. 2, ESInet 1 is the first recipient of incoming requests for service destined for one or more of a second ESInet (232), a second ESRP (228) which may be housed physically or virtually in the second ESInet (226), or a Call Center 218, all discussed in more detail below.

In an embodiment, ESInet 1 may be connected to mobile devices 202 and 204. Mobile devices 202 and 204 may comprise, e.g., a cellular phone, tablet, laptop, notebook, netbook, mobile internet device, portable media player, personal digital assistant, navigation system, or similar system with mobile network connectivity.

In an embodiment, network 214 may communicate with Location Information Server (“LIS”) 216. LIS 216 may be used to provide location services, and may be connected to a database of address information.

In an embodiment, network 214 may communicate with emergency services routing protocol 228 and emergency call routing function 230, all of which may communicate with each other, and which together may be housed, physically or virtually, within a second Emergency Services IP Network (“ESInet 2”). ESInet 2 may be located downstream of ESInet 1, and may be a recipient of messages from mobile devices 202 and 204.

In an embodiment, network 214 may communicate with call center 218, which may be connected to one or more automated or live agents, e.g., exemplary agents 220, 222, and 224. Call center 218 may be located downstream of ESInet 1, and may be a recipient of messages from mobile devices 202 and 204.

In an embodiment, network 214 may communicate with an emergency services routing protocol (or proxy) 2 (“ESRP 2”) 232. ESRP 2 may be located downstream of ESInet 1, and may be a recipient of messages from mobile devices 202 and 204.

According to some embodiments, ESRP 2 (232), ESInet 2 (226), and/or the Call Center (218) may receive additional location information appended to the messages received from mobile devices 202 or 204, such as information retrieved by web services server 208 or location information server 216.

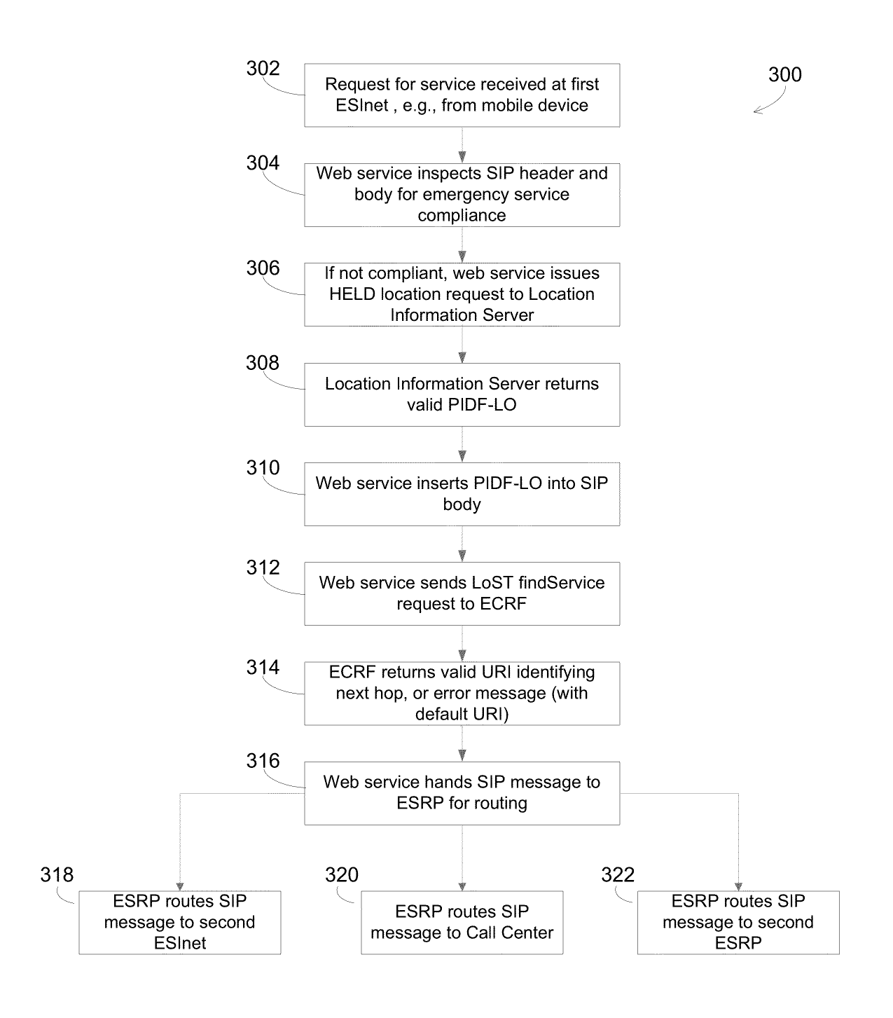

Referring to FIG. 3, in connection with embodiments of the invention, one or more computer systems, which may be interconnected, e.g., to each other and/or to other computer systems, may route messages over a network, e.g., to provide emergency services.

As represented in block 302, in an embodiment, a request for service may be received at ESInet 1, e.g., from mobile devices 202 or 204. The initial request may be transmitted using a sessionless protocol, or another protocol such as the Session Initiation Protocol (SIP), an IETF-defined signaling protocol used for controlling communication sessions such as voice and video calls over Internet Protocol (IP). In embodiments using SIP, each SIP message or packet may contain a header and body.

As represented in block 304, in an embodiment, web service server 208 in ESInet 1 (206) may inspect the SIP header and body in an SIP message for emergency service compliance. Emergency service compliance may be determined using standards created by, e.g., the National Emergency Number Association and/or the Internet Engineering Task Force (IETF). Those skilled in the art will understand that web service server 208 may be adapted to enforce existing as well as new and emerging standards, e.g., the system may be adapted to use a PIDF-LO or other standards. For example, web service server 208 may determine that a SIP header and/or body is not compliant for emergency service if a PIDF-LO is missing or malformed.

As represented in block 306, in an embodiment, if the SIP header or body are not compliant, e.g., if the PIDF-LO is missing or malformed, web service server 208 in ESInet 1 (206) may issue a HELD location request to LIS 216. The HELD location request may include appropriate device identification information, or other information helpful in completing a HELD location request. For example, the device identification information may include, e.g., a Mobile Identification Number (MIN), Internet Protocol (IP) address, Media Access Control (MAC) address, or any other unique identifier.

In an exemplary embodiment, web service server 208 may transmit certain information to LIS 216 to determine whether a call originated from a particular geographic area serviced by an ESInet or related call centers. Such information derived from, e.g., mobile devices 202 or 204, may include ANI and/or PIDF-LO information as discussed, as well as address information and other pertinent information about the address or caller, e.g., agencies that serve that address, such as police, fire department, and ambulance companies. Those skilled in the art will recognize that advanced algorithms and database queries may be used to refine the accuracy of results returned from LIS 216 in combination with the HELD request.

As represented in block 308, in an embodiment, LIS 216 may return a valid PIDF-LO through the HELD location request, in the form of a HELD location response. As represented in block 310, in an embodiment, web service server 208 in ESInet 1 (206) may insert the PIDF-LO returned from LIS 216 into the SIP header or body.

As represented in block 312, in an embodiment, the web service server 208 in ESInet 1 (206) may then send a LoST findService request to ECRF 212 located in ESInet 1 (206). The LoST findService request may be based on the SIP body, or PIDF-LO returned above from the LIS 216. In an embodiment, ECRF 212 may be directly connected to web service server 208.

As represented in block 314, in an embodiment, ECRF 212 may return a valid uniform resource identifier (“URI”) identifying the next hop, or an error message, in which case a default URI will be set.

As represented in block 316, in an embodiment, web service server 208 in ESInet 1 (206) may then hand the SIP message to ESRP 210 in ESInet 1 (206) for routing.

As represented in block 316, in various embodiments, ESRP 210 in ESInet 1 (206) may route the message to one or more of ESInet 2 (232), ESRP 2 (228) which may be housed physically or virtually in ESInet 2 (226), or Call Center 218, to ensure timely delivery of a message to the intended emergency services recipient, along with the necessary location information.

Embodiments of the invention may use protocols such as SMS that do not themselves support sessions, in that nothing in the protocol allows multiple related messages to be treated as part of a common session. Communication using such a protocol may be regarded as sessionless, even though a protocol at another layer of the networking stack may support sessions, or even require them. For example, SMS messages may be sent within a network using TCP, a connection-based protocol, but this transport does not create an SMS session.

An application-layer protocol that supports sessions, such as SIP, may be used for text messaging, and may in some cases be used to carry messages that began as SMS messages. But such use of SIP does not change the fact that SMS itself does not support sessions, and SMS in such circumstances remains a sessionless protocol.

To address this lack of native session support in some protocols, according to some embodiments of the invention, a session may be emulated. In response to receiving the initial message, e.g., from mobile devices 202 or 204, a session may be created, with that session having a pre-determined or dynamically set timeout. In the event of a second message from the same mobile device, and assuming the timeout has not expired, the second message may be sent to the intended recipient in the same session, and with existing or new location information.

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. For instance, except to the extent necessary or inherent in the processes themselves, no particular order to steps or stages of methods or processes described in this disclosure, including the figures, is implied. In many cases the order of process steps may be varied, and various illustrative steps may be combined, altered, or omitted, without changing the purpose, effect or import of the methods described. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

1. A method of routing electronic messages in a voice network, a data network, or both, the method performed by a computer system that comprises one or more processors, one or more network interfaces coupled to at least one of the processors, and one or more computer-readable storage media coupled to at least one of the processors, and the method comprising:
receiving through at least one of the interfaces an initial message embodying a text message that originated from a mobile device at a first location and a first time;
in response to receiving the initial message, automatically transmitting through at least one of the interfaces a service query that comprises the first location;
receiving, through at least one of the interfaces, a response to the service query that identifies a recipient of the message, the recipient being associated with the first location; and
in response to receiving the response to the service query, automatically retransmitting the initial message through at least one of the interfaces to the identified recipient.

2. The method of claim 1, comprising:
in response to receiving the initial message, automatically determining that the initial message lacks location information sufficient to formulate the service query;
in response to determining that the initial message lacks sufficient location information, automatically transmitting through at least one of the interfaces a location query; and
receiving through at least one of the interfaces a response to the location query that comprises sufficient information about the location of the mobile device to formulate the service query.

3. The method of claim 1 or claim 2, comprising:
in response to receiving the initial message, automatically creating a session that is associated with the initial message, the session having a timeout;
at a second time subsequent to the first time, receiving through at least one of the interfaces a second message embodying a second text message from the mobile device;
in response to receiving the second message, automatically determining that the timeout has not expired and resetting the timeout; and
automatically retransmitting the second message through at least one of the interfaces to the recipient.

4. The method of claim 3, wherein at the second time, the mobile device is at a second location that is not associated with the recipient.

5. The method of claim 4, wherein the computer system is programmed so that upon determining, in response to receiving the second message, that the timeout has expired, the computer system at least:
automatically transmits through at least one of the interfaces a second service query that comprises the second location;
receives, through at least one of the interfaces, a response to the second service query that identifies a second recipient, the second in response to receiving the response to the second service query, automatically retransmits the second message through at least one of the interfaces to the second recipient.

6. A computer system for routing electronic messages in a voice network, a data network, or both, the computer system comprising:
one or more processors;
one or more network interfaces coupled to at least one of the processors; and
one or more computer-readable storage media coupled to at least one of the processors, and encoded with instructions that, when executed by at least one of the processors, cause the computer system at least to:
receive through at least one of the interfaces an initial message embodying a text message that originated from a mobile device at a first location and a first time;
in response to receiving the initial message, automatically transmit through at least one of the interfaces a service query that comprises the first location;
receive, through at least one of the interfaces, a response to the service query that identifies a recipient of the message, the recipient being associated with the first location; and
in response to receiving the response to the service query, automatically retransmit the initial message through at least one of the interfaces to the identified recipient.

7. The computer system of claim 6, wherein the instructions comprise instructions that, when executed by at least one of the processors, cause the computer system at least to:
in response to receiving the initial message, automatically determine that the initial message lacks location information sufficient to formulate the service query;
in response to determining that the initial message lacks sufficient location information, automatically transmit through at least one of the interfaces a location query; and
receive through at least one of the interfaces a response to the location query that comprises sufficient information about the location of the mobile device to formulate the service query.

8. The computer system of claim 6 or claim 7, wherein the instructions comprise instructions that, when executed by at least one of the processors, cause the computer system at least to:
in response to receiving the initial message, automatically create a session that is associated with the initial message, the session having a timeout;
at a second time subsequent to the first time, receive through at least one of the interfaces a second message embodying a second text message from the mobile device;
in response to receiving the second message, automatically determine that the timeout has not expired and reset the timeout; and
automatically retransmit the second message through at least one of the interfaces to the recipient.

9. The computer system of claim 8, wherein the instructions are such that the second message is automatically retransmitted to the recipient if the timeout has not expired, even if, at the second time, the mobile device is at a second location that is not associated with the recipient.

10. The computer system of claim 9, wherein the instructions comprise instructions that, when executed by at least one of the processors, cause the computer system at least to:
determine automatically, in response to receiving the second message, that the timeout has expired;
in response to determining that the timeout has expired, automatically transmit through at least one of the interfaces a second service query that comprises the second location;
receive, through at least one of the interfaces, a response to the second service query that identifies a second recipient, the second recipient being associated with the second location; and
in response to receiving the response to the second service query, automatically retransmit the second message through at least one of the interfaces to the second recipient.

11. A computer-readable storage medium encoded with instructions that, when executed by one or more processors within a computer system that comprises one or more network interfaces coupled to at least one of the processors, cause the computer system at least to:
receive through at least one of the interfaces an initial message embodying a text message that originated from a mobile device at in response to receiving the initial message, automatically transmit through at least one of the interfaces a service query that comprises the first location;
receive, through at least one of the interfaces, a response to the service query that identifies a recipient of the message, the recipient being associated with the first location; and
in response to receiving the response to the service query, automatically retransmit the initial message through at least one of the interfaces to the identified recipient.

12. The computer-readable storage medium of claim 11, wherein the instructions comprise instructions that, when executed by at least one of the processors, cause the computer system at least to:
in response to receiving the initial message, automatically determine that the initial message lacks location information sufficient to formulate the service query;
in response to determining that the initial message lacks sufficient location information, automatically transmit through at least one of the interfaces a location query; and
receive through at least one of the interfaces a response to the location query that comprises sufficient information about the location of the mobile device to formulate the service query.

13. The computer-readable storage medium of claim 11 or claim 12, wherein the instructions comprise instructions that, when executed by at least one of the processors, cause the computer system at least to:
in response to receiving the initial message, automatically create a session that is associated with the initial message, the session having a timeout;
at a second time subsequent to the first time, receive through at least one of the interfaces a second message embodying a second text message from the mobile device;
in response to receiving the second message, automatically determine that the timeout has not expired and reset the timeout; and
automatically retransmit the second message through at least one of the interfaces to the recipient.

14. The computer-readable storage medium of claim 13, wherein the instructions are such that the second message is automatically retransmitted to the recipient if the timeout has not expired, even if, at the second time, the mobile device is at a second location that is not associated with the recipient.

15. The computer-readable storage medium of claim 14, wherein the instructions comprise instructions that, when executed by at least one of the processors, cause the computer system at least to:
determine automatically, in response to receiving the second message, that the timeout has expired;
in response to determining that the timeout has expired, automatically transmit through at least one of the interfaces a second service query that comprises the second location;
receive, through at least one of the interfaces, a response to the second service query that identifies a second recipient, the second recipient being associated with the second location; and
in response to receiving the response to the second service query, automatically retransmit the second message through at least one of the interfaces to the second recipient.
